(19) United States
(12) Patent Application Publication
(10) Pub. No.: US 2026/0299107 A1
(43) Pub. Date: Oct. 1, 2026

(54) Multiband Sensor System for Detecting Surroundings, Method, and Motor Vehicle

(71) Applicant: Volkswagen Aktiengesellschaft, Wolfsburg (DE)

(72) Inventors: Heiko Gustav Kurz, Hannover (DE); Tobias SCHWABE, Paderborn (DE); Marc-Michael MEINECKE, Sassenburg (DE); Stephan KRUSE, Paderborn (DE); Christoph SCHEYTT, Dorsten (DE)

(73) Assignee: Volkswagen Aktiengesellschaft, Wolfsburg (DE)

(21) Appl. No.: 19/483,507

(22) PCT Filed: Apr. 25, 2024
(86) PCT No.: PCT/EP2024/061416

§ 371 Date: Nov. 11, 2025

(30) Foreign Application Priority Data
May 11, 2023 (DE) 10 2023 204 354.8

(51) Int. Cl. G01S 13/34; G01S 7/35; G01S 13/86; G01S 13/88

(52) U.S. Cl. CPC G01S 13/34; G01S 7/35; G01S 13/865; G01S 13/88

(57) ABSTRACT

The disclosure relates to a sensor system for detecting surroundings, comprising: an optical apparatus for generating an optical carrier signal, a transmission apparatus, which is designed to emit electrical emission signals which are based on the optical carrier signal, having: an electro-optical modulator, which has a predetermined operating point, the electro-optical modulator, which is designed to generate multiple optical emission signals on the basis of the predetermined operating point and the optical carrier signal in such a way that the multiple optical emission signals have different frequency bands from one another, and the transmission apparatus, which is designed to convert the multiple optical emission signals into multiple electrical emission signals and to emit the multiple electrical emission signals with at least one radio-based transmission unit.

### CROSS-REFERENCE TO RELATED APPLICATIONS

This application claims priority to German Patent Application DE 10 2023 204 354.8, filed on May 11, 2023 with the German Patent and Trademark Office. The contents of the aforesaid Patent Application are incorporated herein for all purposes.

### BACKGROUND

This background section is provided for the purpose of generally describing the context of the disclosure. Work of the presently named inventor(s), to the extent the work is described in this background section, as well as aspects of the description that may not otherwise qualify as prior art at the time of filing, are neither expressly nor impliedly admitted as prior art against the present disclosure.

The disclosure relates to a sensor system for detecting surroundings. The sensor system has an optical apparatus for generating an optical carrier signal. The sensor system also has a transmission apparatus which is designed to emit electrical emission signals based on the optical carrier signal.

The disclosure further relates to a method for operating a sensor system.

The disclosure also relates to a motor vehicle having a sensor system.

### SUMMARY

A need exists to provide an improved sensor system with reduced complexity. The need is addressed by the subject matter of the independent claim(s). Embodiments of the invention are described in the dependent claims, the following description, and the drawings.

### BRIEF DESCRIPTION OF THE DRAWINGS

FIG. 1 is a schematic representation of an example motor vehicle which has an example sensor system according to the teachings herein;

FIG. 2 is a schematic representation of an example computing apparatus and an example transmission apparatus of the sensor system from FIG. 1;

FIG. 3 is a schematic representation of the transmission apparatus from FIG. 2, which additionally has an example optical transmission apparatus;

FIG. 4 is a schematic representation of an example receiving apparatus of the sensor system 2 from FIG. 1;

FIG. 5 is a schematic representation of a further embodiment of the receiving apparatus of the sensor system from FIG. 1; and

FIG. 6 is a schematic representation of a further embodiment of the receiving apparatus of the sensor system from FIG. 1.

### DESCRIPTION

The details of one or more embodiments are set forth in the accompanying drawing and the description below. Other features will be apparent from the description, drawing, and from the claims.

In the following description of embodiments of the invention, specific details are described in order to provide a thorough understanding of the invention. However, it will be apparent to one of ordinary skill in the art that the invention may be practiced without these specific details. In other instances, well-known features have not been described in detail to avoid unnecessarily complicating the instant description.

Some embodiments relate to a sensor system for detecting surroundings, comprising
an optical apparatus for generating an optical carrier signal,
a transmission apparatus which is designed to emit electrical emission signals which are based on the optical carrier
an electro-optical modulator which has a predetermined operating point,
the electro-optical modulator, which is designed to generate multiple optical emission signals on the basis of the predetermined operating point and the optical carrier signal in such a way that the multiple optical emission signals have different frequency bands from one another, and
the transmission apparatus, which is designed to convert the multiple optical emission signals into multiple electrical emission signals and to emit the multiple electrical emission signals with at least one radio-based transmission unit.

The proposed sensor system can be used to create a radar system or a LIDAR-radar combination system that is less complex and still has multiple frequency bands by means of one, in particular a single, electro-optical modulator.

In contrast to today's optically supported radar systems, the proposed sensor System uses multiple frequency bands or else radar frequency bands to detect objects. Thanks to the electro-optical modulator of the sensor system according to the teachings herein, there is no need for a separate phase shifter to generate the bands, in contrast to known multi-band optically assisted radar systems. Such radar or else frequency bands were previously separated using an optical filter and the radar ramp was modulated in a separate electro-optical modulator. This can be improved by the proposed sensor system.

In particular, the proposed sensor system requires only one electro-optical modulator for the generation of radar signals and/or LIDAR signals in different frequency bands or else bands. For example, the sensor system can be a radar system or a LIDAR-radar system. For example, the sensor system can be used as a photonic multi-band LIDAR-radar system.

In contrast to the sensor systems in the prior art, the proposed sensor system does not use separate hardware components for each individual generation of a frequency band. With the help of the proposed sensor system, different frequency bands can be generated with the same component or else unit using the electro-optical modulator.

Furthermore, the proposed sensor system makes it possible to actuate multiple bands or else frequency bands with special hardware, in particular a single piece of hardware, such as the electro-optical modulator. This minimizes the costs and complexity of the overall system, in particular the sensor system, for detecting the surroundings. A further benefit of the sensor system is, for example, that the sensor system can dispense with a mode-locked laser (MLL) and separately actuated phase shifters for the generation of different frequency bands. This also eliminates the need for optical bandpass filters, which separate the bands from each other before each individual frequency band is then actuated separately. This can be dispensed with using the proposed sensor system.

Since the electro-optical modulator of the sensor system can be used to generate or else actuate multiple frequency bands or else radar bands by means of a unit or else a hardware component, the complexity, the probability of failure and the costs of the sensor system can be reduced compared to sensor systems in the prior art.

By dispensing with a phase shifter, which is not possible in the prior art, costs and complexity can be reduced. By dispensing with a mode-locked laser (MLL), which is used in known systems to generate the frequency bands, the sensor system according to the teachings herein has further benefits. Due to their design, MLLs have only a short service life and are very expensive. As a result, the probability of failure of the system having the MLL increases and the system cannot be implemented cost-effectively. For the separation of the frequency bands, additional optical bandpass filters are required, which are discretely very expensive and generate additional energy, such as additional heat dissipation, which in turn must be compensated for. This increases the power loss of the system or else the costs of the system. These mentioned issues of using an MLL can be addressed with the proposed sensor system.

In contrast to the prior art, the proposed sensor system only requires one electro-optical modulator to generate multiple frequency bands or else radar bands. Furthermore, through optical clock distribution, the sensor system can also be used for large-scale equipment systems.

By slightly modifying the hardware, the sensor system can be used as a radar system as well as for radar-LIDAR combination systems. By selecting the required components of the sensor system, the sensor system can be realized as a discrete, integrated or partially integrated solution.

In contrast to the service life problems of a mode-locked laser, the electro-optical modulator has a longer service life, which in turn has a positive effect on the sensor system.

In particular, the electro-optical modulator is designed in such a way that it can generate multiple optical signals which have different frequency bands from each other. For this purpose, the electro-optical modulator can be operated at a predetermined or else special operating point. For example, the electro-optical modulator can be driven or else operated as an operating point at a point at which many, at least some, harmonics of possible identical amplitudes can be generated. In particular, the electro-optical modulator can be operated especially at an operating point at which at least two harmonic signals can be generated. A harmonic can be understood as a harmonic oscillation, the frequency of which is an integer multiple of a base frequency. The base frequency can be predetermined by the optical carrier signal.

In particular, the Nyquist can be used as the operating point. Accordingly, the electro-optical modulator can have an operating mode which can be or else is defined on the basis of the Nyquist point. A Nyquist point or else critical point is a point up to which a system is stable, taking into account the Nyquist criterion. Furthermore, taking into account the Nyquist-Shannon sampling theorem, all portions in a signal can have frequencies lower than the Nyquist frequency so that the sampled signal can be reconstructed with any accuracy. This is beneficial for the present sensor system, since the corresponding radar or else sensor information can be evaluated or else reconstructed accordingly for the detection of objects, in particular for the detection of the surroundings.

With the help of the electro-optical modulator, three frequency bands or else the corresponding signals can be used, for example, simultaneously to detect the surroundings. This is particularly beneficial for improved location classification.

The multiple optical emission signals can be generated coherently to each other, as a result of which these phases are identical. This means that the multiple emission signals generated are coupled to each other in a phase-synchronized manner.

The proposed sensor system can be used in a wide variety of application areas, such as aerospace, shipping, agriculture, the automotive industry or in automotive systems.

In particular, the sensor system can be used in motor vehicles that can move at least partially autonomously, but in particular also those that are operated fully autonomously. In order to make such automated travel possible, reliable perception of the surroundings is essential. Here, the surroundings or else environment is detected by means of sensors, for example radar and/or LIDAR. Comprehensive 360-degree three-dimensional detection of the environment is particularly important, such that all static and dynamic objects can be detected. The sensor system can be used for this purpose. For example, the sensor system can be designed as a photonic radar system or photonic LIDAR-radar system by co-integrating the electronic and photonic components into one, in particular single, semiconductor chip. The tracking of a FMCW signal as well as the overall signal processing and signal evaluation can be carried out in the central station or else central computing apparatus. For example, the optical apparatus can be used to transmit a gigahertz signal as an optical carrier signal, in particular in the terahertz frequency range. A central station, which can also be referred to as a central electronic computing apparatus, generates an optical carrier frequency, in particular the optical carrier signal. In particular, all data, in particular for detecting the surroundings, can be processed on the central station.

Specifically, spectral properties of the optical emission signals can be the same as the electrical emission signals.

For example, the optical apparatus or else an optical laser can generate a 77 gigahertz FMCW signal as a carrier signal.

For example, at least the optical apparatus can be provided to modulate the optical transmission signal or else the optical carrier signal directly and/or by means of external components.

Specifically, the electro-optical modulator can be referred to as an electro-optical converter unit or else electro-optical converter apparatus.

In some embodiments, it is provided that the electro-optical modulator is designed to additionally take into account, for the generation of the multiple optical emission signals, a high-frequency signal provided to the electro-optical modulator. The electro-optical modulator can be designed and, in particular, operated in such a way that multiple optical emission signals, which have different frequency bands from each other, with different frequency bands can be generated. For this purpose, the electro-optical modulator is operated, on the one hand, at the predetermined operating point and the electro-optical modulator can be modulated with the high-frequency signal, in particular additionally.

The high-frequency signal can be an RF signal (radio frequency signal), for example. This high-frequency signal can cover a frequency range from nine kilohertz into the terahertz frequency range.

In some embodiments, it is provided that the transmission apparatus has at least one optical-electronic converter unit, with which the multiple optical emission signals can be converted into the multiple electrical emission signals. For example, the multiple optical emission signals can be transmitted to the transmission apparatus via optical transmission paths or else optical transmission links. For example, this can be done via fiber-optic connections. The transmitted multiple optical emission signals can then be converted by means of one or more optical-electronic or else optical-electrical converter apparatuses such that the multiple electrical emission signals can be provided or else made available to the at least one radio-based transmission unit, such as a radar sensor, for emission.

In addition or instead, the transmission apparatus has at least one frequency manipulator, with which at least one frequency band of one of the multiple electrical emission signals can be changed. For example, the transmission apparatus may have multiple frequency manipulators or else mixers. With the aid of the at least one frequency manipulator, a frequency band of one of the multiple emission signals or multiple frequency bands of the multiple electrical emission signals can be converted into a higher or lower frequency band on the basis a defined bandwidth. This means that frequency conversion can be carried out using the frequency manipulator. In other words, the frequency manipulator can be used to manipulate at least one frequency band of one of the multiple electrical emission signals for emission, in particular for detecting the surroundings.

In addition or instead, the transmission apparatus has at least one electrical amplifier for amplifying at least one frequency band of one of the multiple electrical emission signals. In addition to the at least one electrical amplifier, the transmission apparatus can have further electrical amplifiers. In particular, an amplifier can be provided for each of the multiple electrical emission signals so that a frequency band of each electrical emission signal can be electrically amplified for emission.

In some embodiments, it is provided that the sensor system has an optical transmission unit of the transmission apparatus. The optical transmission unit is designed to emit at least one of the multiple optical emission signals directly. In other words, the transmission apparatus can have various transmission options. The transmission apparatus and thus the sensor system can therefore have both at least one optical transmission unit and at least one radio-based transmission unit. Accordingly, the sensor system according to the teachings herein can be designed as a radar-LIDAR combination system. The sensor system therefore has extended functionality so that it can be used more extensively. The sensor system therefore has two measuring principles. This has a beneficial effect when detecting the surroundings and in particular when detecting objects in an environment. This is particularly beneficial for use in autonomously operated vehicles.

The transmission apparatus can be referred to, for example, as a combination apparatus, which can detect an object and/or the surroundings by means of radio-based, electrical, electromagnetic or optical signals.

The radio-based transmission unit can be an apparatus that can detect the surroundings by means of radio-based, electrical and/or electromagnetic signals. The radio-based transmission unit can therefore be a radar unit, for example. The optical transmission unit or else an optically based transmission unit can be a unit and/or an apparatus that uses optical signals, for example the light of a laser and/or light-emitting diodes (LEDs), to detect an object and/or the surroundings. For example, the optical transmission unit may be a LIDAR unit.

The multiple optical emission signals generated can be provided or else transmitted via optical transmission paths of the radio-based transmission unit as well as of the optical transmission unit, so that the various signals, which have different frequency bands, can be emitted directly, on the one hand, as optical emission signals for detecting the surroundings or can be emitted indirectly as electrical signals by means of conversion and/or manipulation. This means that a sensor system can be provided that can be used as both a LIDAR and a radar system.

In some embodiments, it is further provided that the sensor system has a receiving apparatus which has at least one radio-based receiving unit for receiving at least one electrical reception signal. In addition, the receiving apparatus can have at least one mixer, with which a frequency band of the at least one electrical reception signal can be changed. Furthermore, the sensor system has a computing apparatus which is designed to process the electrical reception signal.

Electrical signals, such as the at least one electrical reception signal, can be received with the aid of the radio-based receiving unit.

For example, the at least one electrical reception signal may be a signal corresponding to the multiple electrical emission signals. In particular, the electrical emission signals are emitted into the environment and when they hit an object, a reflected signal can be reflected back. This can be the electrical reception signal, for example. In particular, the electrical reception signal contains information about the surroundings, in particular radar information. For example, for every emitted electrical emission signal, a corresponding electrical reception signal reflected in the environment can be received by the transmission apparatus.

The at least one received electrical reception signal or the multiple received electrical reception signals can be processed accordingly and its frequency band can be changed, in particular upconverted or downconverted, using, for example, the at least one mixer or else a frequency manipulator.

In particular, the computing apparatus may be a central computing apparatus. The computing apparatus can be connected or else coupled, for example, to the transmission apparatus and/or receiving apparatus so as to transmit signals or else data. The receiving apparatus can have corresponding outputs and inputs so that, for example, the received electrical reception signals can be transmitted to the computing apparatus so that the respective signals can be evaluated or else processed. The surroundings can thus be detected.

For example, the central processing or else processing of data, signals and information, in particular with regard to detecting the surroundings, takes place in the central computing apparatus.

For example, the computing apparatus can be used to control the transmission apparatus and/or the receiving apparatus. In particular, the computing apparatus can be used as an actuation and evaluation unit of the sensor system and, in particular, for the transmission apparatus and for the receiving apparatus.

Accordingly, a wide range of transmission apparatuses and/or receiving apparatuses, for example, can be controlled or else operated or else actuated with one and the same central computing apparatus.

The computing apparatus can be coupled to the transmission apparatus and/or receiving apparatus via one or more optical fibers and/or electrical lines.

In some embodiments, it is provided that the receiving apparatus has at least one optical receiving unit for receiving an optical reception signal, wherein the computing apparatus is designed to process the optical reception signal and, in particular, the receiving apparatus has an optical demodulator for demodulating the optical reception signal. Consequently, the sensor system can be used as a LIDAR-radar combination system. In addition to the radio-based receiving unit, the receiving apparatus can have at least one optical receiving unit or else optical receiving apparatus. The optical receiving unit can be used to receive an optical signal that corresponds, for example, to one of the multiple optical emission signals. Thus, in addition to a radar measuring principle, the sensor system also uses a LIDAR measuring principle.

The optical receiving unit can be integrated, for example, with the radio-based receiving unit in or on the receiving apparatus. It is also conceivable that the optical receiving unit and the radio-based receiving unit are separate units of the receiving apparatus.

Furthermore, the receiving apparatus can have multiple optical receiving units so that corresponding received optical signals can be received in an analog manner to the multiple emitted optical emission signals.

The optical demodulator can be used to recover a useful signal, for example in the baseband, which was previously modulated onto a carrier through modulation. Specifically, an in-phase quadrature phase method (I&Q method) can be carried out, whereby the phase information can be obtained when a high-frequency carrier signal is demodulated.

In addition or instead, the receiving apparatus can have at least one optical-electronic converter unit, with which an optical output signal can be modulated on the basis of at least one of the multiple optical emission signals and the at least one electrical reception signal. In the optical-electronic converter unit or else optical-electronic converter apparatus, which can be referred to, for example, as a detector, the at least one received electrical reception signal and at least one of the optical emission signals can be modulated. Thus, a corresponding optical emission signal can be fed to the optical-electronic converter unit in addition to at least one electrical reception signal, so that an optical output signal can be generated by means of modulation. This in turn can contain information about the surroundings so that this optical output signal can be transmitted to the computing apparatus for further evaluation or else processing.

In particular, an electrical reception signal and an optical emission signal that have at least substantially the same frequency band can be fed to the optical-electronic converter unit.

In some embodiments, the sensor system has a further optical apparatus for generating a further optical carrier signal. Furthermore, the sensor system has a further electro-optical modulator, which is designed to generate multiple optical signals on the basis of the further optical carrier signal in such a way that the multiple optical signals have different frequency bands from each other. In addition, the sensor system has at least one optical-electronic converter unit of the receiving apparatus, with which an optical output signal can be modulated on the basis of at least one of the multiple optical signals and the at least one electrical reception signal. This means that the multiple optical output signals of the electro-optical modulator can optionally be dispensed with for generating or else modulating the optical output signal, since the receiving apparatus is supplied with various optical signals, which have different frequency bands from one another, from a further broadband optical source.

The receiving apparatus can be supplied with a further optical carrier signal with the aid of the optical apparatus, which can be referred to, for example, as an optical source. The further optical transmission signal can be identical to the optical carrier signal. The further electro-optical modulator can be designed similarly to the electro-optical modulator already mentioned.

Some embodiments relate to a method for operating a sensor system according to the teachings herein. The electro-optical modulator is operated in a specific operating mode, wherein in the specific operating mode of the electro-optical modulator, the multiple optical emission signals are generated in such a way that the multiple optical emission signals have different frequency bands from one another.

In particular, the method just described can be used to operate a sensor system as described above. Here, the electro-optical modulator can be operated at an operating point at which as many harmonics of possible identical amplitudes as possible can be generated. This allows different frequency bands to be generated with an electro-optical modulator. This means that the sensor system can be used more extensively, in particular for better detection of the environment.

In some embodiments, it is provided that the electro-optical modulator is operated in the specific operating mode in such a way that the Nyquist point is defined as the operating point of the electro-optic modulator. As a result, multiple harmonic signals can consequently be generated. In particular, the Nyquist point offers the benefit that the multiple optical emission signals are in phase with each other. This allows stable signals to be generated and emitted to detect the surroundings.

Some embodiments relate to a motor vehicle having a sensor system according to the teachings herein. In particular, the motor vehicle just described contains a sensor system as described herein.

In particular, the motor vehicle is an assisted or at least partially autonomously operated vehicle. In particular, the motor vehicle is a highly automated motor vehicle that contains various driver assistance systems. Said driver assistance systems can access the proposed sensor system and call up information about the surroundings, for example. In particular, the motor vehicle may have multiple such sensor systems.

In particular, multiple transmission apparatuses and multiple receiving apparatuses may be arranged in and/or on the motor vehicle. These apparatuses, in turn, can be coupled to the central computing apparatus, which is integrated centrally in the motor vehicle, for example.

The motor vehicle according to the teachings herein is for example designed as an automobile, in particular as a passenger car or truck or as a passenger bus or motorcycle. Moreover, trams, subway trains, railway trains, ships, airplanes, satellites, and other mobile units may also be equipped with this sensor technology.

For example, the units of the sensor system may be arranged so as to be distributed on the motor vehicle, in particular for detecting surroundings. In particular, the sensor system may be a surroundings detection system.

Such a sensor system can, in particular, be used in motor vehicles, rail-bound vehicles, watercraft or in automated systems or in aeronautical engineering or in aerospace engineering. In particular, the sensor system can be used for surroundings detection or else for detecting objects or environmental pollution.

In the embodiments described herein, the described components of the embodiments each represent individual features that are to be considered independent of one another, in the combination as shown or described, and in combinations other than shown or described. In addition, the described embodiments can also be supplemented by features other than those described.

A surroundings sensor system may, for example, be understood as a sensor system that is capable of generating sensor data or sensor signals that depict, represent, or reproduce the environment of the surroundings sensor system. In particular, the ability to detect electromagnetic or other signals from the environment is not sufficient for a sensor system to be considered a surroundings sensor system. For example, cameras, radar systems, lidar systems, and/or ultrasonic sensor systems can be regarded as surroundings sensor systems.

The disclosure also includes embodiments of the motor vehicle according to the teachings herein and of the method according to the teachings herein that have features which have already been described in conjunction with the embodiments of the sensor system according to the teachings herein. To avoid unnecessary repetition, the corresponding embodiments of the motor vehicle and of the method are not described again.

Reference will now be made to the drawings in which the various elements of embodiments will be given numerical designations and in which further embodiments will be discussed.

Specific references to components, process steps, and other elements are not intended to be limiting. Further, it is understood that like parts bear the same or similar reference numerals when referring to alternate FIGS.

Furthermore, in the following, reference is generally only made to one entity for the sake of simplicity. Unless explicitly stated, however, the disclosure may also comprise more than one of the entities concerned. In this regard, the use of the word “a” and “one” should be understood as an indication that at least one entity is used in a simple embodiment.

Where methods are described in the following, the individual steps of a method can be arranged and/or combined in any desired order, unless the context explicitly indicates otherwise. Furthermore, the methods can be combined with one another unless expressly indicated otherwise.

As a general rule, numerical information should not be understood as exact values, but rather also include a tolerance of from +/−1% to +/−10%.

References to standards or specifications should be understood as references to standards or else specifications that apply/applied at the time of the application and/or—if priority is claimed—at the time of the priority application. However, this does not imply a general exclusion of applicability to subsequent or replacement standards or specifications.

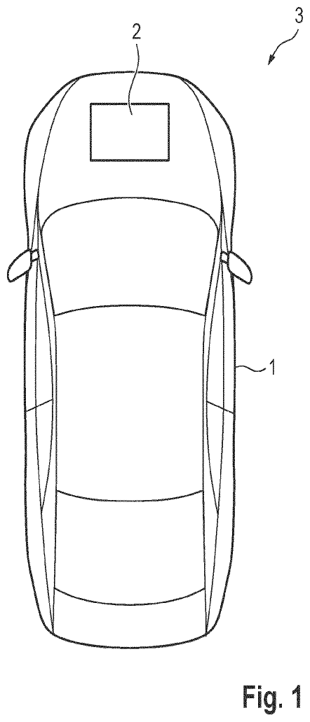

FIG. 1 is a schematic plan view of an embodiment of a motor vehicle 1. The motor vehicle can be designed, for example, as a highly automated vehicle or as an at least partially autonomously operated vehicle.

The motor vehicle 1 can have, for example, a sensor system 2. The sensor system 2 can be used for surroundings detection of an environment 3 of the motor vehicle 1. For example, the sensor system 2 may be a component of a driver assistance system of the motor vehicle 1. In particular, the sensor system 2 supplies corresponding information, in particular relating to the environment 3, to the driver assistance system or a vehicle guidance system.

In addition to the use of the sensor system 2 in the motor vehicle 1, said sensor system can also be used in vehicle-external systems. For example, the sensor system 2 can be applied in automated systems, in aerospace engineering, in aeronautical engineering, or in communication technology.

Again, the example in which the sensor system 2 is integrated into the motor vehicle 1 is shown in FIG. 1 for illustrative purposes.

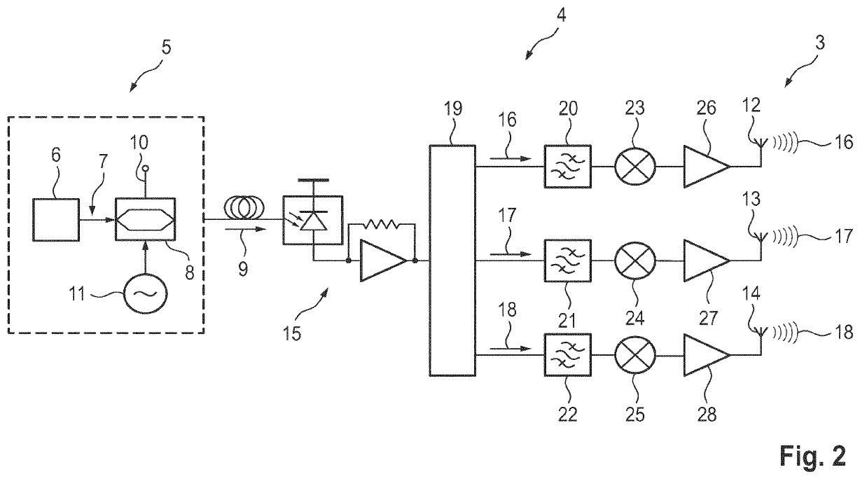

FIG. 2 shows an example of one of multiple embodiments of the sensor system 2 in a representation, in particular in a block diagram.

FIG. 2 shows an example of a transmission apparatus 4 and a computing apparatus 5 of the sensor system 2. The computing apparatus 5 serves, in particular, for the signal processing and/or signal evaluation for the sensor system 2.

The computing apparatus 5 may, for example, be a central processing unit or else a central control unit or else a central actuation unit of the sensor system 2.

In particular, the sensor system 2 has an optical apparatus 6, with which an optical carrier signal 7 or else an optical transmission signal can be provided or else generated. The optical apparatus 6 can be integrated into the computing apparatus 5, as shown as an example in FIG. 2.

The optical apparatus 6 can be, for example, a laser apparatus or else an optical source.

In FIG. 2 shown, the optical apparatus 6 is integrated in the computing apparatus 5. However, this is just one possible example. Equally, the optical apparatus 6 may be designed as a standalone unit.

The sensor system 2 can have an electro-optical modulator 8, which is integrated into or else arranged in the computing apparatus 5, for example. The electro-optical modulator 8 can be used to generate multiple optical emission signals 9 (shown here in simplified form) on the basis of the optical carrier signal 7. In particular, the electro-optical modulator 8 is designed in such a way that radar ramps or else radar signals or else emission signals can be realized in different bands or else frequency bands. Accordingly, the sensor system only requires a single electro-optical modulator 8 for this purpose. To realize this, the electro-optical modulator 8 is operated at a predetermined or else specific operating point. Here, an operating point is driven or else actuated by generating as many harmonics as possible, i.e. harmonic oscillations, the frequency of which is an integer multiple of a base frequency. The base frequency can in turn be provided by means of the optical carrier signal 7. These harmonics can have an identical amplitude. In order to realize this particularly beneficially, the Nyquist point can be used as the operating point 10.

On the basis of the operating point 10 and the optical carrier signal 7, the multiple optical emission signals 9 can be generated in such a way that the multiple optical emission signals 9 have different frequency bands from one another. For this purpose, the electro-optical modulator 8 can optionally be additionally modulated with a high-frequency signal 11. This may be, above all, an RF signal.

To detect the surroundings, the sensor system 2 has at least one transmission apparatus 4, which has at least one radio-based transmission unit 12. In this exemplary embodiment, three or else multiple radio-based transmission units 12, 13, 14 are shown. The radio-based transmission unit 12, 13, 14 can be a unit or else apparatus based on a radar sensor.

The multiple optical transmission signals 9 generated can be transmitted or else sent to the transmission apparatus 4 or other transmission apparatuses of the sensor system 2, for example, via optical transmission paths, such as optical fibers. The transmission apparatus 4 can have, for example, at least one optical-electronic converter unit 15. This converter unit 15 is used for opto-electronic conversion of the multiple optical emission signals 9 into multiple electrical emission signals 16, 17, 18. After conversion, the electrical output signals 16, 17, 18 can be separated accordingly by means of a splitter 19, in particular according to their frequency band. The distributor 19 can be, for example, a “1×3 power divider.” Furthermore, a narrow-band opto-electronic converter or an electrical bandpass filter can be used as a distributor 19. In the connection to the distributor 19, the electrical emission signals 16, 17, 18 can be separated or else divided according to their frequency bands 20, 21, 22. For example, the electrical emission signals 16, 17, 18 and also the multiple optical emission signals 9 can be coherent with each other and, in particular, in phase with each other. Accordingly, the proposed sensor system 2 can be operated or else used in such a way that measurements are taken simultaneously or else synchronously on multiple different frequency bands, as shown in FIG. 2 on three different frequency bands. This is particularly beneficial for location classification with regard to surroundings detection.

After the electrical emission signals 16, 17, 18 have been separated, their respective frequency bands 20, 21, 22 can be changed, in particular upconverted, using a frequency manipulator 23, 24, 25 or else a frequency mixer. Furthermore, the respective frequency bands 20, 21, 22 can then be amplified by means of respective electrical amplifiers 26, 27, 28. After the electrical emission signals 16, 17, 18 have been upconverted and amplified, they can be emitted or else radiated into the environment 3 by means of respective radio-based transmission units 16, 17, 18, which can be referred to, for example, as antennas, in order to detect the surroundings.

For example, the transmission apparatus 4 can be referred to as a transmission module. The transmission apparatus 4 can be controlled or else operated, for example, with the aid of the computing apparatus 5 so that at least one radar-based signal, i.e. the signals 16, 17, 18, can be emitted. In particular, the embodiment in FIG. 2 shows the use of the sensor system 2 as a radar system. The electro-optical modulator 8 according to the teachings herein can be used to create a multi-band radar. In particular, this can be referred to as “Nyquist pulse multi-band radar.”

The computing apparatus 5 can be a spatially and/or physically separate unit from the transmission apparatus 4. In this case, the computing apparatus 5 and the transmission apparatus 4 can be connected via multiple optical transmission paths or else optical transmission links in order to exchange or else transmit the optical signals. In a further embodiment, it is also possible that the transmission apparatus 4 and the computing unit 5 are integrated into a common unit.

FIG. 2 shows, for example, that the different frequency bands 20, 21, 22 of the emission signals can be emitted with a transmission apparatus 4. It is also conceivable that a separate transmission apparatus 4 is used for each emission signal or else for each frequency band.

In particular, the sensor system 2 can be designed or else configured accordingly depending on the application.

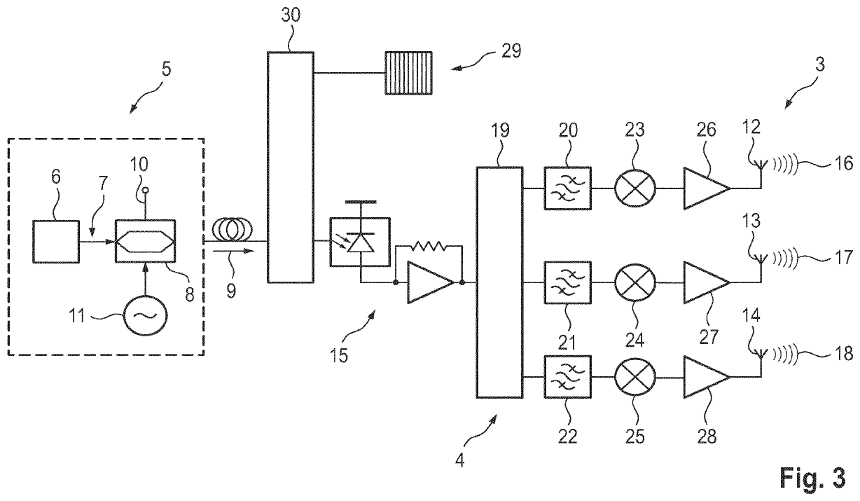

In a further embodiment of the sensor system 2, the use of the sensor system 2 as a LIDAR-radar combination system is shown in FIG. 3. With regard to the generation of the multiple optical emission signals 9 and the emission of the multiple electrical emission signals 16, 17, 18, reference is again made to the explanations in FIG. 2. The embodiment in FIG. 3 differs from the embodiment in FIG. 2 in that the sensor system 2 additionally has at least one optical transmission unit 29. This optical transmission unit 29 can be a LIDAR-based sensor in particular. With the aid of the optical transmission unit 29, at least one of the multiple optical emission signals 9 can be emitted directly to detect the surroundings. After the generation of the multiple optical emission signals 9 by means of an optical unit 30, which can be designed, for example, as a “1×2 splitter,” the optical emission signals 9 can be distributed or else branched off. Thus, on the one hand, the optical emission signals 9, as already explained in FIG. 2, can be transmitted to the radio-based transmission units 12, 13, 14 for conversion into the electrical emission signals 16, 17, 18. In addition, the optical emission signals 9 of the at least one optical transmission unit 29 or other optical transmission units can be transmitted.

For example, the optical transmission unit 29 may be a component of the transmission apparatus 4. It is also conceivable that the optical transmission unit 29 is designed separately from the transmission apparatus 4.

Thus, the embodiment in FIG. 3 can be used to combine a radar system and a LIDAR system, namely with the sensor system 2. The computing apparatus 5 can be used for common actuation and evaluation. Furthermore, radar and LIDAR signals or else the radio-based signals and the optics-based signals can be coherent with each other and combined signal processing can be provided for the transmission units 12, 13, 14, 29 with the aid of the computing apparatus 5.

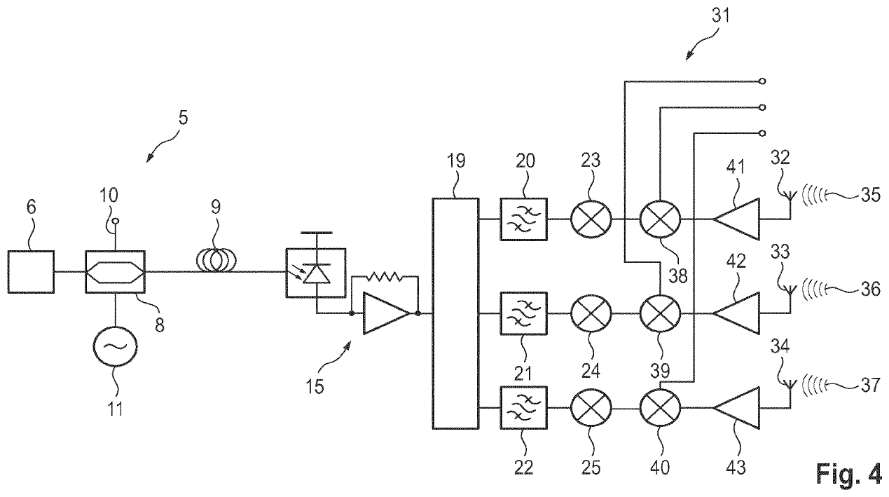

FIG. 4 shows an embodiment of a receiving apparatus 31 of the sensor system 2. For example, the receiving apparatus 31 can be in combination with the transmission apparatus 4. These can be at least partially integrated into an apparatus. For example, the transmission apparatus 4 and the receiving apparatus 31 can be combined in one combination using interchangeable or else actuatable components, so that it is possible to switch between a receiving mode and a transmitting mode, for example, as required.

The receiving apparatus 31 can have at least one radio-based receiving unit 32, 33, 34. These can be radar-based receiving units. With the aid of the radio-based receiving units 32, 33, 34, at least one electrical reception signal 35, 36, 37 can be received. The reception signal or else reception signals 35, 36, 37 can be signals corresponding to the electrical emission signals 16, 17, 18 and reflected in the environment 3.

In particular, the transmission apparatus 4 and the receiving apparatus 31 can be complementary to each other.

For example, the received electrical reception signals 35, 36, 37 can be downconverted by means of at least one mixer 38, 39, 40. In the process, in particular, the respective frequency bands of the reception signals 35, 36, 37 are changed or else adjusted. In addition, depending on the signal strength of the received reception signals 35, 36, 37, amplification can take place by means of respective amplifiers 41, 42, 43. The electrical reception signals 35, 36, 37 can then be provided at electrical outputs. Here, these can be transmitted to the computing apparatus 5 or another evaluation or else processing unit.

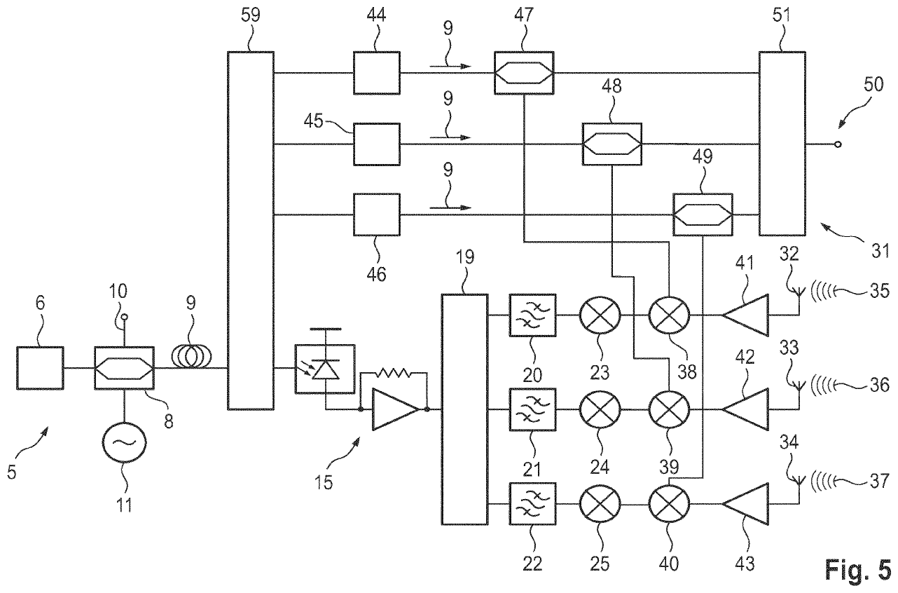

In a further embodiment, FIG. 5 shows an expansion of the receiving apparatus 31 from FIG. 4.

In the embodiment in FIG. 5, the receiving apparatus 31 is designed in particular in such a way that optical retransmission can take place. Here, the multi-band optical emission signals 9 can be split again into the individual optical carriers or else the individual frequency bands by means of optical filters 44, 45, 46. For this purpose, the optical emission signals 9 can in turn be split or else selected via a unit 59, for example a “1×4 power splitter.” For example, the optical filters 44, 45, 46 may utilize a time-of-flight method (ToF). The split and thus filtered emission signals 9 can then be modulated on or else with the received electrical reception signals 35, 36, 37. In turn, at least one optical-electronic converter unit 47, 48, 49 can be used for this purpose. Thus, an optical output signal 50 is modulated here, for example, on the basis of the emission signals 9 and the reception signals 35, 36, 37. For this purpose, after the processes of the converter units 47, 48, 49, the signals can in turn be combined by means of a unit 51, such as a “1×3 power combiner,” so that the optical output signal 50 can be provided, for example, at an optical output. This in turn can be made available or else transmitted to the computing apparatus 5 or another processing unit.

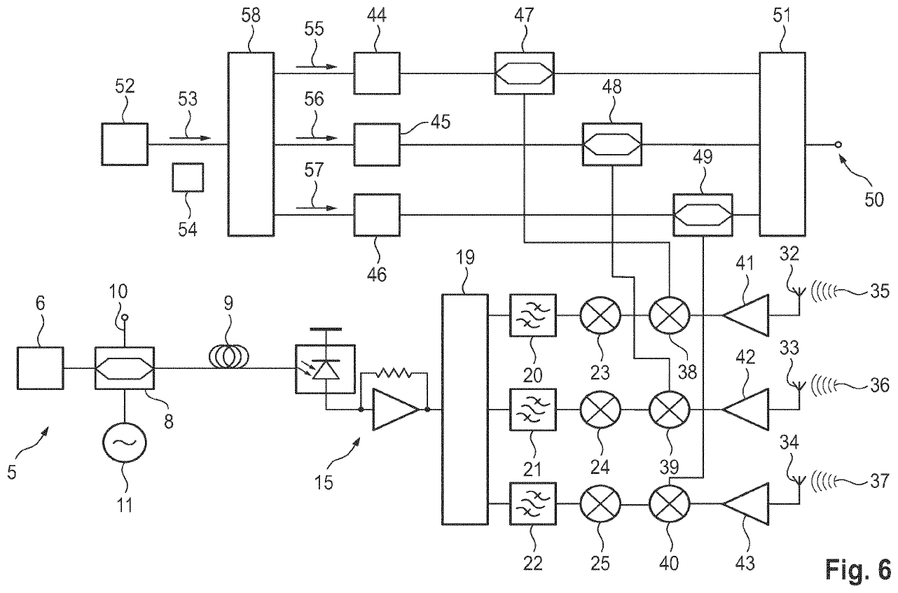

FIG. 6 Shows an alternative to the transmission apparatus 31 represented in FIG. 5. Here, in turn, a receiving circuit with an optical output is shown as in FIG. 5, wherein here, however, the respective frequency bands of a further broadband optical source are used. A further optical apparatus 52 can be used for this purpose. This can generate a further optical carrier signal 53. The carrier signal 53 can in turn be the same as the carrier signal 7. The further optical apparatus 52 may be a further optical source. By means of a further electro-optical modulator 54, which can for example be designed identically to the electro-optical modulator 8, multiple optical signals 55, 56, 57 can be generated on the basis of the carrier signal 53. In this way, the carrier signal 53 can in turn be divided into multiple bands or else frequency bands. A distributor 58, such as a “1×3 power splitter,” can be used for this purpose. The modulator 54 can also be operated at the operating point 10 similarly to the modulator 8. The bands or else frequency bands of the signals 55, 56, 57 can then be split again by means of the optical filters 44, 45, 46 and then modulated. The converter units 47, 48, 48 can in turn be used here. Thus, the optical output signal can be generated by means of modulation on the basis of the optical signals 55, 56, 57 and the received electrical reception signals 35, 36, 37.

Another alternative to the apparatus 52 would be the use of a broadband optical source.

It is also conceivable to modulate the light from one or more optical sources separately for each reception signal 35, 36, 37. Furthermore, the sensor system 2 for use as a LIDAR-radar combination system can have at least one optical receiving unit for receiving an optical reception signal. This optical reception signal can correspond to a directly emitted emission signal 9. For this purpose, the computing apparatus 5 can in turn be designed to process the optical reception signal. Furthermore, the optical reception signal can be demodulated by means of an optical demodulator.

The embodiments in FIGS. 2 to 6 can be combined with each other in different ways depending on the application or else application area of the sensor system 2.

In particular, the computing apparatus 5, the transmission apparatus 4 and the receiving apparatus 31 can be physically and/or spatially separate units. Alternatively, the transmission apparatus 4, the receiving apparatus 31, and the computing apparatus 5 can be formed together as a common unit.

### LIST OF REFERENCE NUMERALS

1 Motor vehicle
2 Sensor system
3 Environment
4 Transmission apparatus
5 Computing apparatus
6 Optical apparatus
7 Optical carrier signal
8 Electro-optical modulator
9 Multiple optical emission signals
10 Operating point
11 High-frequency signal
12, 13, 14 Radio-based transmission unit
15 Optical-electronic converter unit
16, 17, 18 Multiple electrical emission signals
19 Distributor
20, 21, 22 Frequency bands
23, 24, 25 Frequency manipulator
26, 27, 28 Amplifier
29 Optical transmission unit
30 Optical unit
31 Receiving apparatus
32, 33, 34 Radio-based receiving unit
35, 36, 37 Electrical reception signals
38, 39, 40 Mixer
41, 42, 43 Amplifier
44, 45, 46 Optical filters
47, 48, 49 Optical-electronic converter unit
50 Optical output signal
51 Unit
52 Further optical apparatus
53 Further optical carrier signal
54 Further electro-optical modulator
55, 56, 57 Multiple optical signals
58 Distributor
59 Distributor

The invention has been described in the preceding using various example embodiments. Other variations to the disclosed embodiments may be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor, device, or other unit may be arranged to fulfil the functions of several items recited in the claims. Likewise, multiple processors, devices, or other units may be arranged to fulfil the functions of several items recited in the claims.

The term “exemplary” used throughout the specification means “serving as an example, instance, or exemplification” and does not mean “preferred” or “having advantages” over other embodiments. The terms “in particular” and “particularly” used throughout the specification means “for example” or “for instance”.

The mere fact that certain measures are recited in mutually different dependent claims or embodiments does not indicate that a combination of these measures cannot be used to advantage. Any reference signs in the claims should not be construed as limiting the scope.

What is claimed is:

1-10. (canceled)

11. A sensor system for detecting surroundings, comprising:
an optical apparatus for generating an optical carrier signal;
a transmission apparatus, which is configured to emit electrical emission signals which are based on the optical carrier signal;
an electro-optical modulator, which has a predetermined operating point, wherein the electro-optical modulator is configured to generate multiple optical emission signals on the basis of the predetermined operating point and the optical carrier signal in such a way that the multiple optical emission signals have different frequency bands from one another; wherein the transmission apparatus is configured to convert the multiple optical emission signals into multiple electrical emission signals and to emit the multiple electrical emission signals with at least one radio-based transmission unit.

12. The sensor system of claim 11, wherein the electro-optical modulator is configured to additionally take into account, for the generation of the multiple optical output signals, a high-frequency signal provided to the electro-optical modulator.

13. The sensor system of claim 11, wherein the transmission apparatus has at least one optical-electronic converter unit, with which the multiple optical emission signals can be converted into the multiple electrical emission signals, and/or
the transmission apparatus has at least one frequency manipulator, with which at least one frequency band of one of the multiple electrical emission signals can be changed, and/or
the transmission apparatus has at least one electrical amplifier for amplifying at least one frequency band of one of the multiple electrical emission signals.

14. The sensor system of claim 11, wherein an optical transmission unit of the transmission apparatus is configured to emit at least one of the multiple optical emission signals directly.

15. The sensor system of claim 11, further comprising:
a receiving apparatus which has at least one radio-based receiving unit for receiving at least one electrical reception signal, in particular the receiving apparatus has at least one mixer, with which a frequency band of the at least one electrical reception signal can be changed; and
a computing apparatus which is configured to process the electrical reception signal.

16. The sensor system of claim 15, wherein the receiving apparatus has at least one optical receiving unit for receiving an optical reception signal, wherein the computing apparatus is configured to process the optical reception signal, in particular the receiving apparatus has an optical demodulator for demodulating the optical reception signal, and/or
the receiving apparatus has at least one optical-electronic converter unit, with which an optical output signal can be modulated on the basis of at least one of the multiple optical emission signals and the at least one electrical reception signal.

17. The sensor system of claim 15, comprising: a further optical apparatus for generating a further optical carrier signal;
a further electro-optical modulator, which is configured to generate multiple optical signals on the basis of the further optical carrier signal in such a way that the multiple optical signals have different frequency bands from one another; and
at least one optical-electronic converter unit of the receiving apparatus, with which an optical output signal can be modulated on the basis of at least one of the multiple optical signals and the at least one electrical reception signal.

18. A method for operating the sensor system of claim 11, wherein the electro-optical modulator is operated in a specific operating mode, wherein in the specific operating mode of the electro-optical modulator, the multiple optical emission signals are generated in such a way that the multiple optical emission signals have different frequency bands from each other.

19. The method of claim 18, wherein the electro-optical modulator is operated in the specific operating mode in such a way that the Nyquist point is defined as the operating point of the electro-optical modulator.

20. A motor vehicle having a sensor system, wherein the sensor system comprises:
an optical apparatus for generating an optical carrier signal;
a transmission apparatus, which is configured to emit electrical emission signals which are based on the optical carrier signal;
an electro-optical modulator, which has a predetermined operating point, wherein the electro-optical modulator is configured to generate multiple optical emission signals on the basis of the predetermined operating point and the optical carrier signal in such a way that the multiple optical emission signals have different frequency bands from one another; wherein
the transmission apparatus is configured to convert the multiple optical emission signals into multiple electrical emission signals and to emit the multiple electrical emission signals with at least one radio-based transmission unit.

21. The motor vehicle of claim 20, wherein the electro-optical modulator is configured to additionally take into account, for the generation of the multiple optical output signals, a high-frequency signal provided to the electro-optical modulator.

22. The motor vehicle of claim 20, wherein the transmission apparatus has at least one optical-electronic converter unit, with which the multiple optical emission signals can be converted into the multiple electrical emission signals, and/or
the transmission apparatus has at least one frequency manipulator, with which at least one frequency band of one of the multiple electrical emission signals can be changed, and/or
the transmission apparatus has at least one electrical amplifier for amplifying at least one frequency band of one of the multiple electrical emission signals.

23. The motor vehicle of claim 20, wherein an optical transmission unit of the transmission apparatus is configured to emit at least one of the multiple optical emission signals directly.

24. The motor vehicle of claim 20, further comprising:
a receiving apparatus which has at least one radio-based receiving unit for receiving at least one electrical reception signal, in particular the receiving apparatus has at least one mixer, with which a frequency band of the at least one electrical reception signal can be changed; and
a computing apparatus which is configured to process the electrical reception signal.

25. The motor vehicle of claim 24, wherein the receiving apparatus has at least one optical receiving unit for receiving an optical reception signal, wherein the computing apparatus is configured to process the optical reception signal, in particular the receiving apparatus has an optical demodulator for demodulating the optical reception signal, and/or
the receiving apparatus has at least one optical-electronic converter unit, with which an optical output signal can be modulated on the basis of at least one of the multiple optical emission signals and the at least one electrical reception signal.

26. The motor vehicle of claim 20, comprising: a further optical apparatus for generating a further optical carrier signal;
a further electro-optical modulator, which is configured to generate multiple optical signals on the basis of the further optical carrier signal in such a way that the multiple optical signals have different frequency bands from one another; and
at least one optical-electronic converter unit of the receiving apparatus, with which an optical output signal can be modulated on the basis of at least one of the multiple optical signals and the at least one electrical reception signal.
